(19) United States
(12) Patent Application Publication
(10) Pub. No.: US 2011/0170849 A1
(43) Pub. Date: Jul. 14, 2011

(54) IMAGE CAPTURING DEVICE HAVING OPTICAL PRISMS

(75) Inventor: JEN-TSORNG CHANG, Tu-Cheng (TW)

(73) Assignee: HON HAI PRECISION INDUSTRY CO., LTD., Tu-Cheng (TW)

(21) Appl. No.: 12/846,812

(22) Filed: Jul. 29, 2010

(30) Foreign Application Priority Data
Jan. 13, 2010 (CN) 201010300214.2

(51) Int. Cl. G03B 41/00; H04N 5/225

(52) U.S. Cl. 396/322; 348/218.1; 348/E05.03

(57) ABSTRACT

An image capturing device includes a circuit board, a first camera module capturing a first image, a second camera module capturing a second image, and a processor stitching the two images into a panoramic image. The two camera modules are arranged on the circuit board. The first camera module includes a first barrel and a first optical prism. The first prism includes a first light incident surface positioned on the top of the first barrel to seal the first barrel and an inclining first light emitting surface. The structure of the second camera module is the same as the first camera module. The first optical prism tapers in a direction toward the second camera module, the second optical prism tapers in a direction toward the first camera module.

### BACKGROUND

1. Technical Field

The present disclosure relates to imaging technologies and, particularly, to an image capturing device that has optical prisms.

2. Description of Related Art

Generally, an image capturing device only captures an image in a direction that the image capturing device is aimed. The filed of view is so limited that people only look at what an operator chooses to focus on. In order to solve this problem, an image capturing device having two camera modules is used for capturing two independent sub-images. The two sub-images are then stitched together to obtain a panoramic image with a wider view. However, with the development of panoramic photography, capturing areas of two camera modules are also limited and can not meet people's demands.

Therefore, what is need is to provide an image capturing device, in which the limitations described, are eliminated or at least alleviated.

### BRIEF DESCRIPTION OF THE DRAWINGS

FIG. 1 is a schematic view of an image capturing device including a first camera module, according to a first exemplary embodiment.

FIG. 2 is a schematic view of a light beam passing through the first camera module of FIG. 1.

FIG. 3 is a schematic view of an image capturing device, according to a second exemplary embodiment.

FIG. 4 is a schematic view of an image capturing device, according to a third exemplary embodiment.

### DETAILED DESCRIPTION

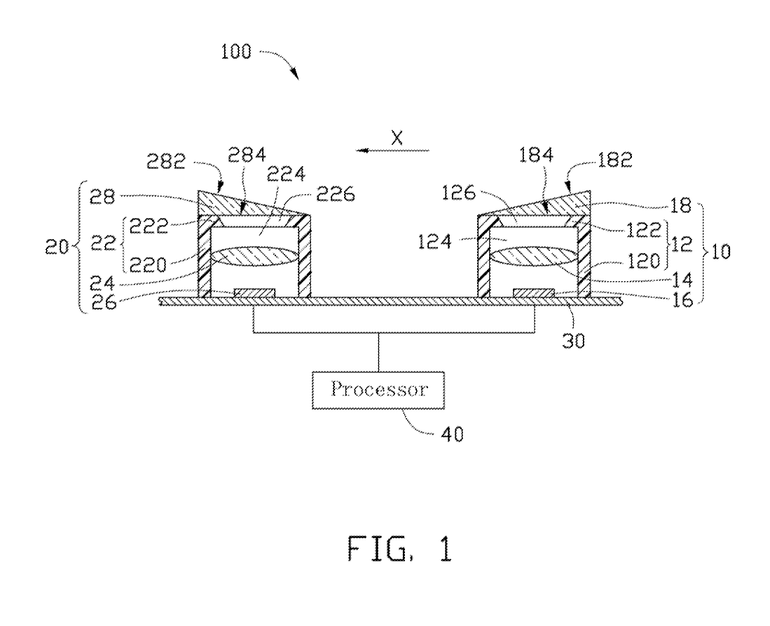

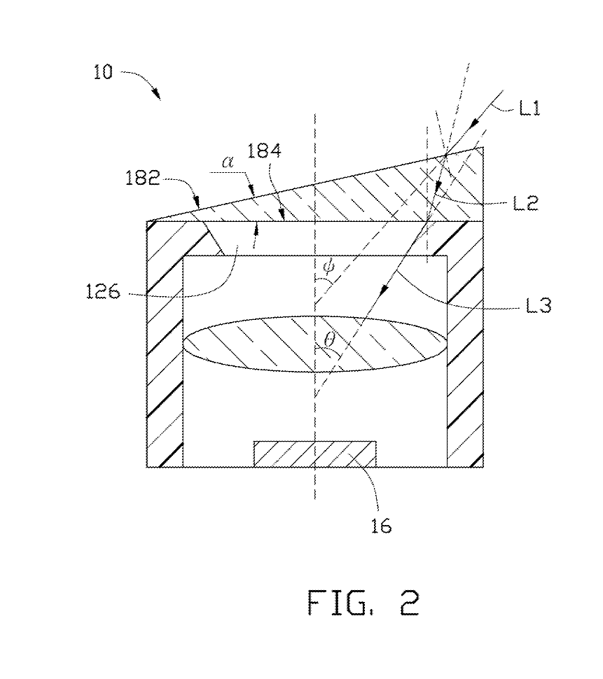

Referring to FIGS. 1-2, an image capturing device 100, according to a first exemplary embodiment, includes a first camera module 10, a second camera module 20, a circuit board 30, and a processor 40. The first camera module 10 and the second camera module 20 are arranged in a line on the circuit board 30 and spaced apart from each other.

The first camera module 10 includes a first barrel 12, a first lens 14, a first image sensor 16, and a first optical prism 18.

The first barrel 12 is attached to the circuit board 30. The first barrel 12 includes a first receiving portion 120 and a first front portion 122 extending from the first receiving portion 120. The first receiving portion 120 has a cylindrical shape and defines a first passage 124 therein. A first cone-shaped hole 126 is located in the center of the first front portion 122 and communicates with the first passage 124. A diameter of the first cone-shaped hole 126 gradually decreases from the object side to the image side of the first camera module 10.

The first lens 14 may be made of, glass or resin and can be an aspherical lens or a spherical lens for example. The first lens 14 is received in the first passage 124. The first image sensor 16 is positioned on the circuit board 30 and received in the first passage 124. The first image sensor 16 is electrically connected to the circuit board 30. A sensing area of the first image sensor 16 is aligned with the first lens 14.

The first optical prism 18 is wedge-shaped and is positioned on the first front portion 122 to seal the first cone-shaped hole 126. The first optical prism 18 is a rectangular prism and includes a first light incident surface 182 and a first light emitting surface 184. The first light emitting surface 184 is in contact with the first front portion 122. The first light incident surface 182 inclines relative to the first light emitting surface 184. Incident light beams refracted by the first light incident surface 182 and the first light emitting surface 184 emits toward the first cone-shaped hole 126, the first passage 124, and the first lens 14 and finally reaches the first image sensor 16. The distance from the first light incident surface 182 to the first light emitting surface 184 gradually decreases along a direction (arrow X shown in FIG. 1) from the first camera module 10 to the second camera module 20. In other words, the first optical prism 18 tapers in a direction toward the second camera module 20.

The second camera module 20 includes a second barrel 22, a second lens 24, a second image sensor 26, and a second optical prism 28.

The second barrel 22 is attached to the circuit board 30. The second barrel 22 includes a second receiving portion 220 and a second front portion 222 extending from the second receiving portion 220. The second receiving portion 220 has a cylindrical shape and defines a second passage 224 therein. A second cone-shaped hole 226 is defined in the center of the second front portion 222 and communicates with the second passage 224. A diameter of the second cone-shaped hole 226 gradually decreases from the object side to the image side of the second camera module 20.

The second lens 24 may be made of, glass or resin and can be an aspherical lens or a spherical lens for example. The second lens 24 is received in the second passage 224. The second image sensor 26 is positioned on the circuit board 30 and received in the second passage 224. The second image sensor 26 is electrically connected to the circuit board 30. A sensing area of the second image sensor 26 is aligned with the second lens 24.

The second optical prism 28 is wedge-shaped and is positioned on the second front portion 222 to seal the second cone-shaped hole 226. The second optical prism 28 is a rectangular prism and includes a second light incident surface 282 and a second light emitting surface 284. In the illustrated embodiment, a wedge angle α of the second optical prism 28, i.e. an included angle between the second light incident surface 282 and the second light emitting surface 284 is equal to a wedge angle α of the first optical prism 18. The second light emitting surface 284 is in contact with the second front portion 222. The second light incident surface 282 inclines relative to the second light emitting surface 284. Incident light beams refracted by the second light incident surface 282 and the second light emitting surface 284 emits toward the second cone-shaped hole 226, the second passage 224, and the second lens 24 and finally reaches the second image sensor 26. The distance from the second light incident surface 282 to the second light emitting surface 284 gradually increases along a direction (arrow X shown in FIG. 1) from the first camera module 10 to the second camera module 20. In other words, the second optical prism 28 tapers in a direction toward the first camera module 10.

The processor 40 is connected to the circuit board 30. The processor 40 is configured for stitching images captured by the first camera module 10 and the second camera module 20 to obtain a panoramic image with a wider view.

When in use, the first light incident surface 182 refracts a light beam on a first path L₁ to follow a second path L₂. The first light emitting surface 184 refracts the light beam on the second path L₂ to follow a third path L₃ toward the first cone-shaped hole 126 and reaches the first image sensor 16. The light beams whose half view angle in a range from 0˜ψ can enter in the first lens 14 and reach the first image sensor 16. The first camera module 10 captures a first image. If the first optical prism 18 is removed, only light beams whose half view angle in a range from 0˜θ can enter in the first lens 14 and reach the first image sensor 16. As shown in FIG. 2, θ<ψ, and ψ=arcsin(n sin(α+arcsin (sin θ/n))), wherein α is the included angle between the first light incident surface 182 and the first light emitting surface 184, n is the refraction index of the first optical prism 18. As a result, the field of view of the first camera module 10 increases. Similarly, the second camera module 20 captures a second image and the filed of view of the second camera module 20 increases. The first image and the second image are stitched together by the processor 40 to obtain a panoramic image with a wider view.

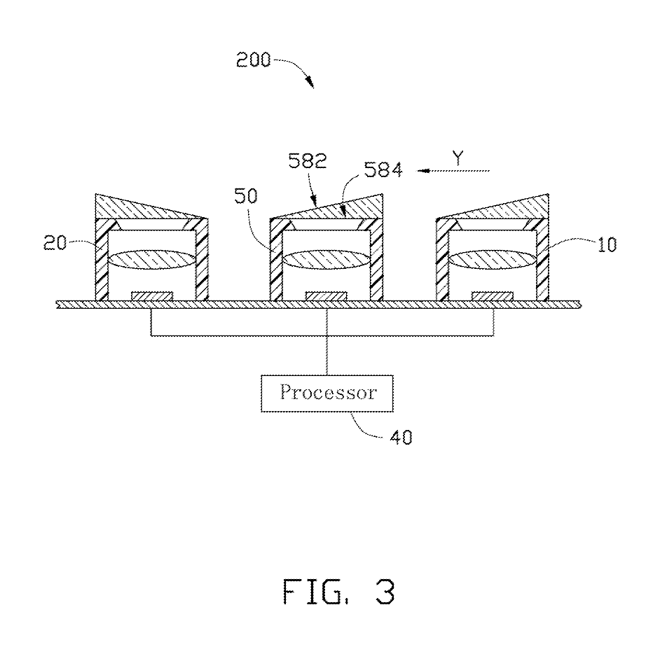

Referring to FIG. 3, an image capturing device 200, according to a second exemplary embodiment, is shown. The difference between the image capturing device 200 of this embodiment and the image capturing device 100 of the first embodiment is: the image capturing device 200 further includes a third camera module 50. The third camera module 50 is positioned on the circuit board 30 between the first camera module 10 and the second camera module 20. The third camera module 50 is similar to the first camera module 10 and the second camera module 20. The distance from the third light incident surface 582 to the third light emitting surface 584 gradually decreases along a direction (arrow Y shown in FIG. 3) from the first camera module 10 to the second camera module 20. The third camera module 50 captures a third image. The first image, the second image, and the third image are stitched together by the processor 40 to obtain a panoramic image with a wider view. In other embodiments, the distance from the third light incident surface 582 to the third light emitting surface 584 gradually increases along the direction (arrow Y shown in FIG. 3) from the first camera module 10 to the second camera module 20.

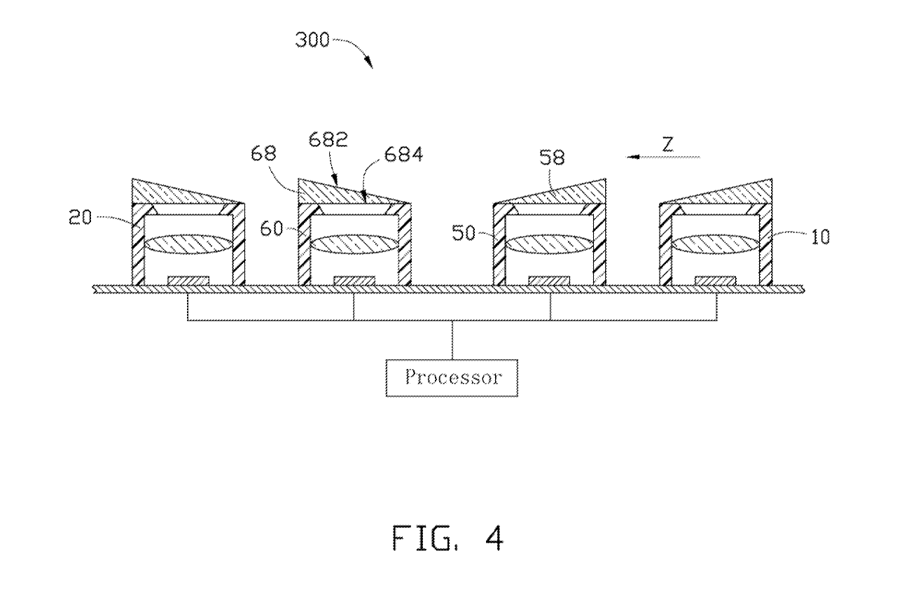

Referring to FIG. 4, an image capturing device 300, according to a third exemplary embodiment, is shown. The difference between the image capturing device 300 of this embodiment and the image capturing device 200 of the second embodiment is: the image capturing device 300 further includes a fourth camera module 60. The fourth camera module 60 is similar to the first camera module 10, the second camera module 20, and the third camera module 50. The distance from the fourth light incident surface 682 to the fourth light emitting surface 684 gradually increases along a direction (arrow Z shown in FIG. 4) from the first camera module 10 to the second camera module 20. A wedge angle of the fourth optical prism 68, i.e. an included angle between the fourth light incident surface 682 and the fourth light emitting surface 384 is equal to a wedge angle of the third optical prism 58. In this embodiment, the wedge angle of the first optical prism 18 or the second optical prism 28 is larger than that of the third optical prism 58 or the fourth optical prism 68. In other embodiments, the distance from the fourth light incident surface 682 to the fourth light emitting surface 684 gradually decreases along a direction (arrow Z shown in FIG. 4) from the first camera module 10 to the second camera module 20

The advantages of the image capturing devices of the second exemplary embodiment and the third second exemplary embodiment are similar to those of the image capturing device of the first exemplary embodiment.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An image capturing device, comprising:
a circuit board;
a first camera module configured for capturing a first image, the first camera module attached to the circuit board, the first camera module comprising a first barrel and a first optical prism, the first optical prism comprising a first light incident surface and a first light emitting surface, the first light emitting surface positioned on the top of the first barrel to seal the first barrel, the first light incident surface inclining relative to the first light emitting surface;
a second camera module configured for capturing a second image, the second camera module attached to the circuit board, the second camera module comprising a second barrel and a second optical prism, the second optical prism comprising a second light incident surface and a second light emitting surface, the second light emitting surface positioned on the top of the second barrel to seal the second barrel, the second light incident surface inclining relative to the second light emitting surface, the first optical prism tapering in a direction toward the second camera module, the second optical prism tapering in a direction toward the first camera module; and
a processor connected to the circuit board and configured for stitching the first image and the second image to obtain a panoramic image.

2. The image capturing device as claimed in claim 1, wherein the first barrel comprises a first receiving portion and a first front portion extending from the first receiving portion, the first receiving portion defines a passage, a first cone-shaped hole is defined in the center of the first front portion and communicates with the first passage, the first light incident surface is positioned on the first front portion to seal the first cone-shaped hole.

3. The image capturing device as claimed in claim 2, wherein the first camera module comprises a first lens, a first image sensor, the first lens is received in the first passage, the first image sensor positioned on the circuit board and received in the first passage.

4. The image capturing device as claimed in claim 3, wherein the first optical prism is a wedge-shaped rectangular prism.

5. The image capturing device as claimed in claim 1, wherein the second barrel comprises a second receiving portion and a second front portion extending from the second receiving portion, the second receiving portion defines a passage, a second cone-shaped hole is defined in the center of the second front portion and communicates with the second passage, the second light incident surface is positioned on the second front portion to seal the second cone-shaped hole.

6. The image capturing device as claimed in claim 5, wherein the second camera module comprises a second lens, a second image sensor, the second lens is received in the second passage, the second image sensor positioned on the circuit board and received in the second passage.

7. The image capturing device as claimed in claim 6, wherein the second optical prism is a wedge-shaped rectangular prism.

8. The image capturing device as claimed in claim 1, further comprising a third camera module positioned on the circuit board between the first camera module and the second camera module, the third camera module configured for capturing a third image.

9. The image capturing device as claimed in claim 8, wherein the third camera module comprises a third barrel and a third optical prism, the third optical prism comprises a third light incident surface and a third light emitting surface, the third light emitting surface is positioned on the top of the third barrel to seal the third barrel, the third light incident surface inclines relative to the third light emitting surface.

10. The image capturing device as claimed in claim 9, wherein the third optical prism tapers along a direction that from the first camera module to the second camera module.

11. The image capturing device as claimed in claim 10, wherein the third optical prism tapers along a direction from the second camera module to the first camera module.

12. An image capturing device, comprising:
a circuit board;
two first camera modules mounted on the circuit board, each first camera module comprising a lens module, a first wedge-shaped prism optically coupled to the lens module, and an image sensor for capturing an image, the first wedge-shaped prism tapering toward each other; and
two second camera modules mounted on the circuit board and arranged between the first camera modules, each second camera module comprising a lens module, a second wedge-shaped prism optically coupled to the lens module, and an image sensor for capturing an image, the second wedge-shaped prism tapering toward each other; and
a processor connected to the circuit board and configured for stitching the images to obtain a panoramic image.

13. The image capturing device as claimed in claim 12, wherein a wedge angle of each second wedge-shaped prism is less than a wedge angle of each first wedge-shaped prism.
